(19) United States
(12) Patent Application Publication
(10) Pub. No.: US 2008/0191903 A1
(43) Pub. Date: Aug. 14, 2008

(54) Optoelectronic Device for Assisting Aircraft Taxing Comprising Dedicated Imaging

(75) Inventors: Bernard Dubourg, Le Haillan (FR); Eric Filliatre, Merignac (FR); Nicolas Delfour, Evreux (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/995,099

(22) PCT Filed: Jul. 7, 2006
(86) PCT No.: PCT/EP2006/064030

§ 371 Date: Jan. 8, 2008

(30) Foreign Application Priority Data
Jul. 8, 2005 (FR) 0507323

(51) Int. Cl. G08G 5/00

(52) U.S. Cl. 340/958

(57) ABSTRACT

The field of the invention is that of optoelectronic taxiing-aid devices for aircraft, comprising a so-called head-up display enabling information to be presented in the visual field of the pilot. It applies more particularly to large civilian aircraft of the Boeing 747 or Airbus A380 type. The purpose of the invention is to present, in the display, a set of ergonomic symbols for informing the pilot of the path to be followed in a turn and the exact situation of his vehicle on the taxiway, enabling him to taxi in total safety, including in bad weather conditions. These symbols comprise lateral safety marks, represented by posts of variable height, representing the limit of the taxiway, positioned at regular intervals and located either side of the center line of the taxiway and equidistant from the latter. When the taxiing conditions are such that these posts are no longer visible in the display, a view from above of the situation of the aircraft on the taxiway is displayed.

### CROSS-REFERENCE TO RELATED APPLICATIONS

The present Application is based on International Application No. PCT/EP2006/064030, filed on Jul. 07, 2006, which in turn corresponds to French Application No. 05 07323 filed on Jul. 8, 2005, and priority is hereby claimed under 35 USC §119 based on these applications. Each of these applications are hereby incorporated by reference in their entirety into the present application.

### BACKGROUND OF THE INVENTION

1. Field of the Invention

The field of the invention is that of optoelectronic taxiing-aid devices for aircraft, comprising a so-called head-up display enabling information to be presented in the visual field of the pilot. It applies more particularly to large civilian aircraft of the Boeing 747 or Airbus A380 type.

2. Description of the Prior Art

It is important for the ground taxiing phases of the aircraft in an airport to be able to be carried out in total safety regardless of the air traffic density or visibility conditions. An aircraft landing gear often has a large footprint and occupies a significant portion of the width of the taxiways. For example, the width of the landing gear of an Airbus A380 exceeds 14 meters. One major objective for safety is that, during taxiing, all the landing gear should remain perfectly on the taxiway in order to avoid the aircraft approaching too close to obstacles in the vicinity of the taxiway or prevent the landing gear from leaving the runway.

One of the difficulties in taxiing is negotiating turns. In practice, as illustrated in FIG. 1, in a first level airplane A, the pilot P is located at a height H of a few meters above the ground with a large area Z of nonvisibility below the vehicle. Thus, in an Airbus A380, the pilot is positioned 7 meters above the ground and the area Z of nonvisibility shown shaded in FIG. 1 extends over 25 meters. Also, the large distance separating the main landing gear and the nose wheel R of the vehicle does not facilitate maneuvering. In an Airbus A380, the latter distance reaches 30 meters.

Modern aircraft include a taxiing-aid system comprising in particular a head-up display, also called HUD. A head-up display conventionally comprises an image source generating the system of symbols, collimation optics and an optical combiner placed in the visual field of the pilot. The display thus gives a virtual image to infinity of the system of symbols superimposed on the external landscape.

The symbol system gives information on the path to be followed and a certain number of instructions. It is generated by a computer dedicated to the display. In the case of the taxiing-aid system, the information is supplied to the display computer by:

the main navigation system, particularly for heading, ground speed and position information;

the airport navigation computer, from:
taxiing instructions supplied by the air traffic controller, following taxiway segments that the airplane should follow during the taxiing phase, and
information contained in a database relating to the airport platform on which the airplane is located. There are three categories of database giving a description of the airports, called “Coarse”, “Medium” and “Fine”, defined in document RTCA DO272/EUROCAE ED99, entitled “Users Requirements for Aerodrome Mapping Information”. For this type of application, the databases used are of the “Fine” category.

The overall capacity for monitoring the situation of the aircraft and the accuracy of the maneuvers to be performed manually depends directly on the characteristics and the ergonomics of the various symbols presented to the pilot through his HUD.

Conventionally, the symbols displayed in a head-up display are separated into two broad categories:

Symbols called 2D symbols, also called nonconforming symbols, which provide the pilot with navigation information comprising, for example:
the horizon line;
the final destination of the path;
the next stopping point called “clearance limit”;
the estimated time or distance of the aircraft to a final routing point;
the changes of direction to be made;
the ground speed of the aircraft;
the magnetic heading;

symbols called 3D symbols, or conforming symbols, which give a better perception of the environment of the aircraft. These symbols are particularly useful in degraded visibility conditions, for example for nighttime navigation or because of poor weather conditions. These are mainly symbols representing the taxiway. The virtual image of this symbol system supplied by the display is superimposed precisely in the real position of the taxiway, the position of the aircraft relative to the taxiway being perfectly known to the nearest meter by means of the navigation systems.

FIG. 2 gives an example of a taxiing-aid symbol system according to the prior art when the aircraft begins a turn. This symbol system has been simplified and only the elements necessary for the invention have been retained. The bold line outline in FIG. 2 and the subsequent figures represents the angular limits of the optical combiner. This symbol system comprises:

a conforming 3D representation in which the symbols presented are superimposed exactly on the external elements that they represent. These symbols are:
rectangular axial taxiway marks 100. These rectangles are shown in perspective, their orientation and their size depending on their position relative to the aircraft;
circular lateral taxiway safety marks 200 which, of course, appear in the form of ellipses in FIG. 2;
the horizon line 300;

a nonconforming 2D representation. As an example, a change of direction 400 is represented, it is symbolized by the text TURN followed by an indication of the number of meters to be traveled before the next turn of the aircraft, in this case 91 meters in FIG. 2.

This representation is appropriate as long as the vehicle is entering the turn or as long as the visibility conditions are good. However, when the vehicle is in the middle of a turn, this representation becomes inadequate. As can be seen in FIG. 3, it is perfectly possible in the middle of a turn V, given the area Z of nonvisibility represented by the shaded area and located in front of the vehicle A, for the displayed symbol system no longer to include any usable lateral safety mark. If, on the other hand, the visibility is reduced, the pilot is then totally deprived of information and visual markers.

### SUMMARY OF THE INVENTION

The invention applies within the framework of this taxiing-aid function. It applies more particularly when the aircraft enters into a turn. The object of the invention is to present, in the HUD, a set of ergonomic symbols enabling the pilot to be informed of the path to be followed in a turn and the exact situation of his airplane on the taxiway, enabling him to taxi in total safety, even in poor weather conditions.

More specifically, the subject of the invention is an optoelectronic taxiing-aid device for aircraft located on an airport taxiway, said device comprising at least one head-up display and a computer dedicated to said display, said computer comprising means of displaying on the display at least so-called 3D symbols, superimposed on said taxiway and representing lateral safety marks, positioned at regular intervals and located either side of the center line of the taxiway and equidistant from the latter, characterized in that, in the turns, said marks are posts of variable height, representing the limit of the taxiway.

Advantageously, the posts of variable height are located only on the outside of the turns, the virtual maximum height of the posts is less than the height at which the eyes of the pilot are located above the taxiway, so that all the posts appear in the display under the horizon line; the posts are substantially cylindrical in shape, the generatrix of the cylinder being perpendicular to the taxiway.

Advantageously, from entering the turn to leaving the turn, the height of the posts first of all increases gradually, then remains constant, then decreases gradually.

Furthermore, the computer also generates a first set of 2D symbols representing a change of direction, comprising the following basic elements:

a curve direction arrow indicating the direction of the turn and the angle of the curve of said turn;

the name of the next taxiway, said name being placed at the end of the curve direction arrow;

the textual indication of the turn consisting of the text “TURN” and the distance remaining before beginning the turn expressed in meters.

In this case, the curve direction arrow diminishes when the aircraft advances in the curve, the textual indication of the turn being displaced so as to always remain positioned at the end of the curve arrow. This first set of symbols is displayed when the aircraft is less than 200 meters from a curve and disappears at the end of that curve.

The computer can also generate a second set of 2D symbols representing the situation of the main landing gear of the aircraft and comprising the following basic elements:

a model of the main landing gear of the aircraft, comprising in particular the bogies;

a representation of the taxiway to the same scale as that of the model of the main landing gear;

indices showing the ideal position of the outer bogies of the main landing gear when the airplane is centered on the taxiway.

The model of the main landing gear then occupies a fixed position in the display, the representation of the taxiway and the indices being mobile. The model of the main landing gear blinks when the main landing gear is too close to the edge of the taxiway and the representation of the taxiway consists of a horizontal line delimited by two vertical lines showing the safety limits of the taxiway.

Finally, the computer can also generate a third set of 2D symbols representing a view from above of the situation of the aircraft on the taxiway and comprising the following basic elements represented to the same scale:

axial rectangular marks positioned at regular intervals representing the center line of the taxiway;

lateral taxiway safety marks, a series of posts positioned at regular intervals, located either side of the center line of the taxiway and equidistant from the latter;

a model of the landing gear seen from above, comprising all the main landing gear and the nose wheel of the aircraft;

an airplane model representing the aircraft seen from above.

In this case, the various bogies of the main landing gear and the nose wheel of the aircraft are linked by straight-line segments.

This third set is generated to offset the reference loss when the 3D symbols representing the lateral safety marks are no longer visible in sufficient numbers in the display because of the position of the piloting station in the turns. A display criterion for this view is, for example, the total disappearance from the field of the display of the axial taxiway marks. Thus, the reference loss linked to the presentation of the external limit of the turn is anticipated.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a front view of an aircraft with its area of nonvisibility;

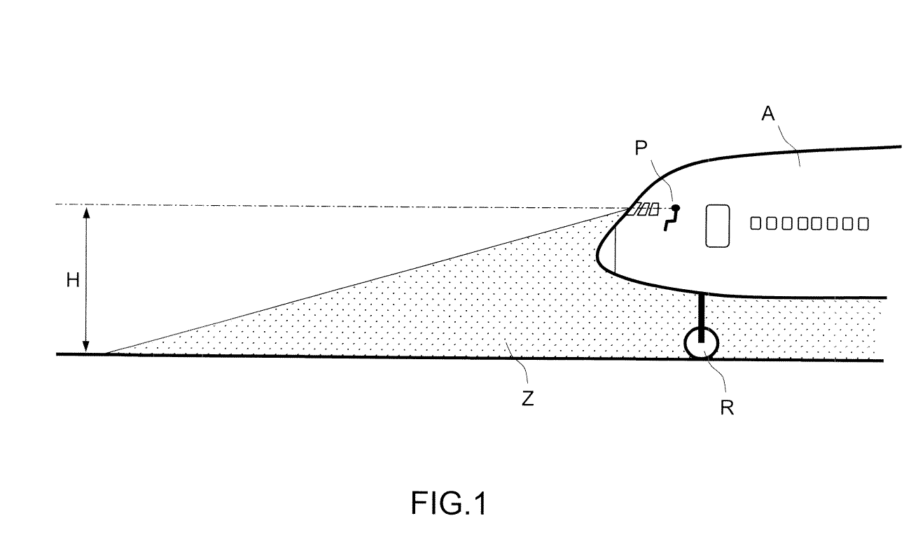

FIG. 2 represents a symbol system displayed in a display according to the prior art;

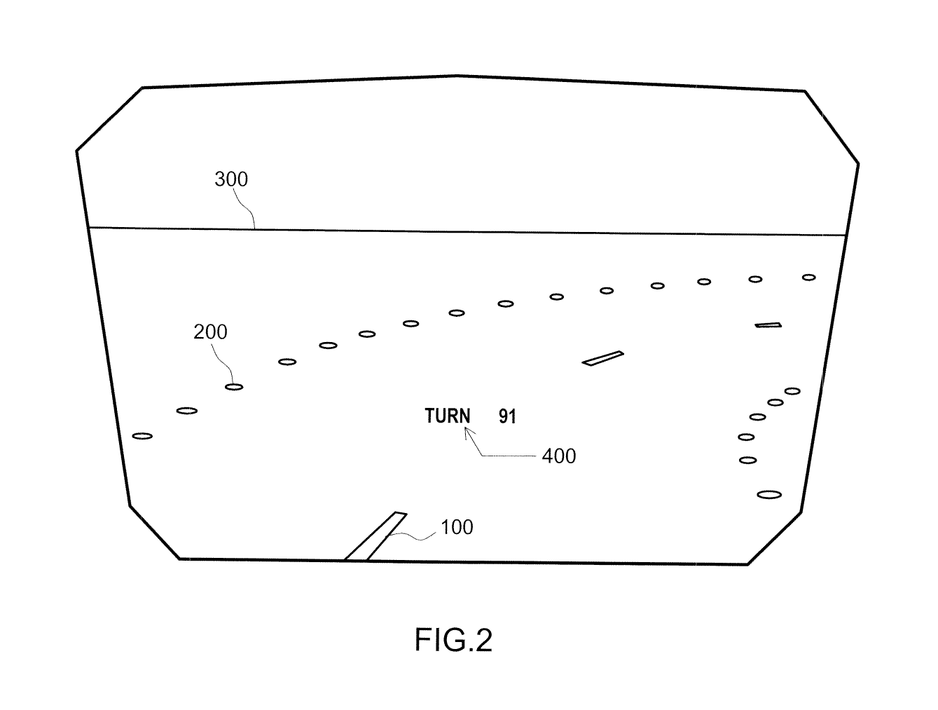

FIG. 3 represents a view from above of an airplane beginning a turn on a taxiway;

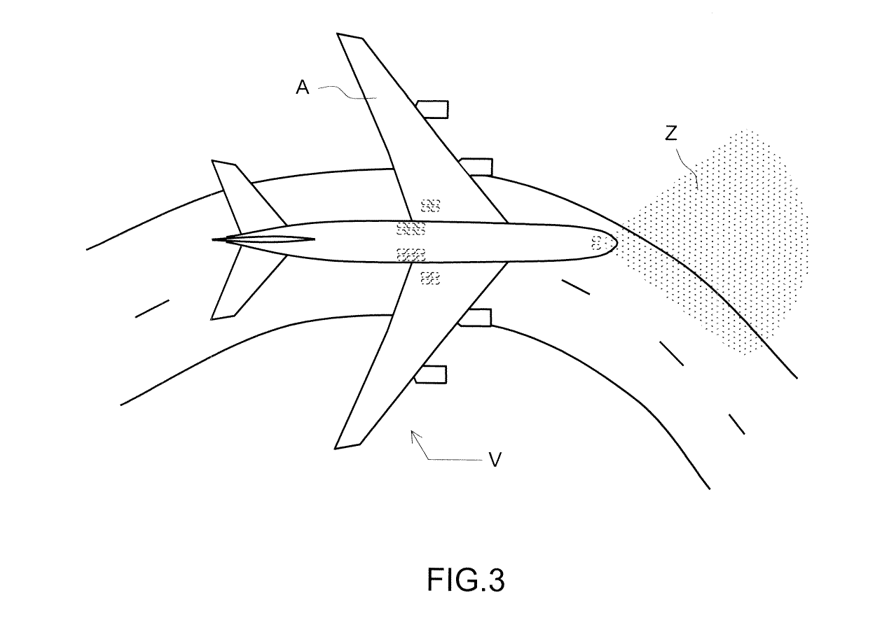

FIG. 4 represents a symbol system according to the invention in a first configuration;

FIG. 5 represents a symbol system according to the invention in a second configuration.

### MORE DETAILED DESCRIPTION

The symbol system according to the invention always makes it possible to supply the pilot with the information needed to ensure that his aircraft can taxi in total safety, including in turns.

This symbol system comprises at least:

a conforming 3D representation in which the symbols presented are superimposed exactly on the external elements that they represent. These symbols are:
axial taxiway marks;
lateral taxiway safety marks;

a nonconforming 2D representation which makes it possible to supply the pilot with additional information when the 3D representation is not adequate to correctly assess the situation of the airplane on the taxiways. These symbols mainly concern:
a change of direction;
the situation of the main landing gear;
the situation in a turn of the airplane.

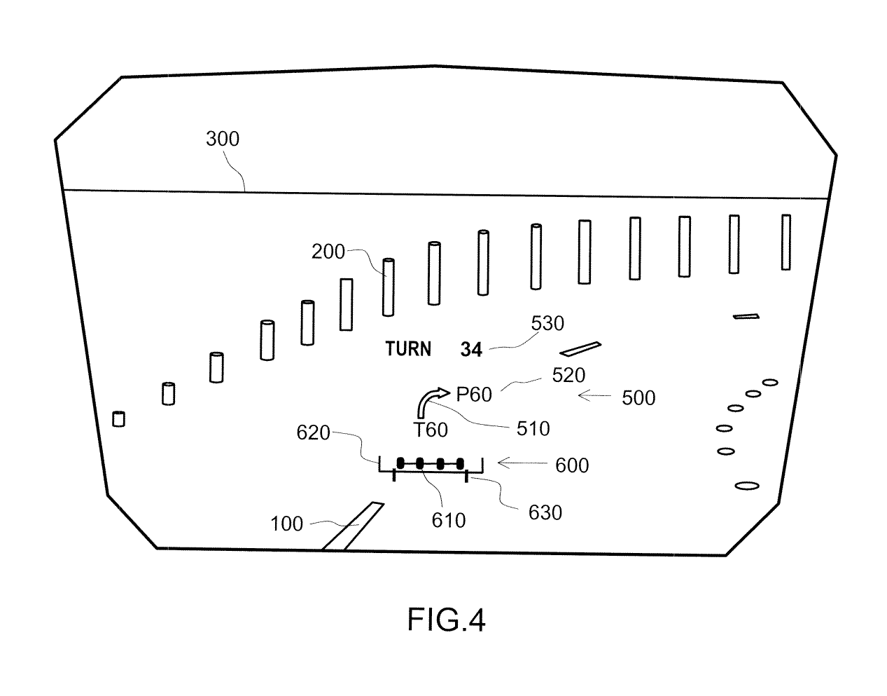

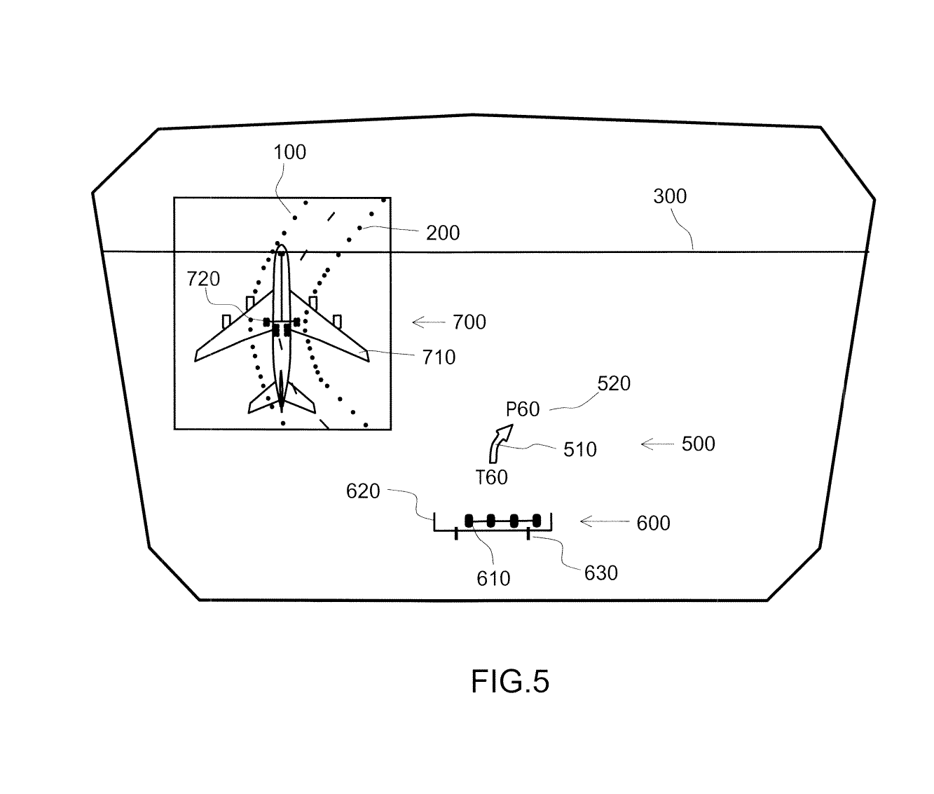

Of course, the angular size of the symbols projected to infinity is adapted for the symbols to be easily legible. FIGS. 4 and 5 show examples of this symbol system. It is detailed below:

Axial Taxiway Marks 100

The axial taxiway marks are plotted in 3D so as to conform to the external view of the landscape. They are a series of rectangular marks positioned at regular intervals, superimposed on the ground markings showing the axial taxiway line.

Lateral Taxiway Safety Marks 200

The lateral taxiway safety marks are plotted in 3D so as to conform to the external view of the landscape. In the turns, these marks are posts of variable height positioned on the outside of the turn, at regular intervals, showing the limit of the taxiway not to be exceeded. The pilot thus retains, when he begins a curve, a reference of the external limit of the taxiway for as long as possible despite the dead angle of vision due to the height and the advanced position of the piloting station relative to the main landing gear of the airplane.

The height of the posts increases gradually during the first part of the curve, then remains constant until the end of the latter enabling the pilot to better appreciate the angle and the length of this curve. It then diminishes in the straight line following the curve.

In a straight line and for the representation of the inside of the turn, the height of the posts representing the lateral marks is zero. Their representation is therefore a circle. Thus, we avoid unnecessarily overloading the symbol system presented in the head-up display.

The maximum height of the posts is adapted to each type of vehicle to take account of characteristics of each airplane and the constraints for maneuvering the latter in the curves so as to keep all the landing gear on the taxiway. It is preferable for the virtual maximum height of the posts to be less than the height at which the eyes of the pilot are located above the taxiway, so that all the posts appear in the display under the horizon line, which makes it possible to separate the horizon from any symbol system.

Depending on the size of each airplane, the nose of the vehicle is more or less close to the limit of the taxiways. For some very large carrier vehicles, the nose can thus be located above areas external to the taxiways. It is then possible to consider angling the posts towards the outside of the turn in order to keep the top of the posts always visible, even when the position of the pilot used as a reference for the display is beyond the external limit of the turn.

Set of 2D Symbols 500 Representing a Change of Direction

The set of symbols representing a change of direction consists of the following basic elements:

a curve direction arrow 510 indicating the direction of the turn and the angle of the curve;

the name 520 of the next taxiway;

the textual indication 530 of the turn consisting of the text “TURN” and the remaining distance expressed in meters.

This set appears when the airplane approaches within 200 meters of a curve and disappears at the end of this curve.

The textual turn indication is presented when the airplane approaches the start of the curve and disappears when the airplane enters the curve.

The curve direction arrow diminishes when the airplane advances in the curve so enabling the pilot to know the position of his vehicle in the curve. The name of the next taxiway is displaced according to the situation of the airplane in the curve while always remaining positioned at the end of the curve arrow.

When the airplane leaves the turn, the curve arrow disappears completely and only the name of the taxiway on which the airplane is now located is displayed.

Set of 2D Symbols 600 Representing the Situation of the Main Landing Gear

The set of symbols representing the situation of the main landing gear consists of the following basic elements:

a model 610 of the main landing gear of the aircraft, comprising in particular the bogies;

a representation 620 of the taxiway to the same scale as that of the model of the main landing gear;

indices 630 showing the ideal position of the outer bogies of the main landing gear when the airplane is centered on the taxiway.

This representation is produced within the frame of reference of the vehicle. Consequently, the model of the main landing gear occupies a fixed position in the display, the representation of the taxiway and of the indices being mobile.

Said model of the main landing gear blinks when the main landing gear is too close to the edge of the taxiway. The representation of the taxiway conventionally comprises a horizontal line delimited by two vertical lines showing the safety limits of the taxiway.

The indices can, for example, be small vertical lines.

The pilot can thus best assess the situation of the main landing gear relative to the taxiway on which his vehicle is located and deduce therefrom the maneuvers to be made to keep the vehicle in the taxiing domain.

Set of 2D Symbols 700 Representing the Turn Situation of the Airplane

These provide a representation from above of the situation of the airplane on the taxiways. This set of symbols consists of the following elements:

rectangular marks 100 positioned at regular intervals representing the center line of the taxiway;

lateral taxiway safety marks 200, a series of posts positioned at regular intervals, located either side of the center line of the taxiway and equidistant from the latter;

a model 720 of the landing gear seen from above, comprising all the main landing gear and the nose wheel of the aircraft;

an airplane model 710 representing the aircraft seen from above.

In this case, the various bogies of the main landing gear and the nose wheel of the aircraft are linked by straight-line segments. This third set is generated to offset the reference loss when the 3D symbols representing the lateral safety marks are no longer visible in sufficient numbers in the display because of the position of the piloting station in the turns. A criterion for displaying this view is, for example, the total disappearance of the axial taxiway marks from the field of the display, thus making it possible to anticipate the reference loss linked to the presentation of the external limit of the turn.

The set of information presented above thus permanently communicates to the pilot the exact position of his airplane on the taxiway. He can then anticipate the next maneuvers to be made, so ensuring optimum performance and enhanced safety.

Furthermore, in the taxiing phases in poor visibility, the time aspect of the control of the airplane by the crew becomes crucial and this new symbol system presents the advantage:

of increasing the overall situation monitoring level,

of enhancing the responsiveness of the pilot.

As nonlimiting examples, FIGS. 4 and 5 present two exemplary applications of the symbol system according to the invention in taxiing conditions.

In FIG. 4, the symbol system presented comprises:

the center line of the taxiway shown by segments 100;

the safety limit of the edge of the taxiway shown externally by raised posts 200 and by circular posts on the inside of the turn.

It gives the following information:

the airplane is currently taxiing on the taxiway denoted T60, it is approaching a 90 degree turn to the right. The turn is 34 meters away. The next taxiway is P60;

the main landing gear of the airplane is well centered relative to the center line of the taxiway.

In FIG. 5, with the vehicle being very engaged in the turn, the piloting station is located above the edge of the taxiway and the symbols associated with the taxiway are no longer present in the visual field of the HUD. Thus, the symbol system presented gives the following information:

the aircraft is engaged in a turn. The direction arrow indicates that there remains an angle of approximately 45 degrees before finishing the turn;

the main landing gear of the airplane is very close to the right edge of the taxiway. In this case, the model of the main landing gear blinks;

the view from above shows the situation of the aircraft relative to the taxiway. It informs the pilot of the exact situation of his aircraft relative to the taxiway.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalent thereof.

1-16. (canceled)

17. An optoelectronic taxiing-aid device for aircraft located on an airport taxiway, said device comprising:
heads-up display and a computer dedicated to said display; said computer comprising means of displaying on the display 3D symbols, superimposed on said taxiway and representing lateral safety marks, positioned at regular intervals and located either side of a center line of the taxiway and equidistant from the center line, wherein, in the turns, said display generates on the display said marks in the form of posts of variable height, representing limits of the taxiway.

18. The optoelectronic device as claimed in claim 17, wherein the posts of variable height are located only on outside of the turns.

19. The optoelectronic device as claimed in claim 17, wherein the virtual maximum height of the posts is less than a height at which the eyes of the pilot are located above the taxiway, so that all the posts appear in the display under a horizon line.

20. The optoelectronic device as claimed in claim 17, wherein the posts are substantially cylindrical in shape, a generatrix of the cylinder being perpendicular to the taxiway.

21. The optoelectronic device as claimed in claim 17, wherein, from entering the turn to leaving the turn, a height of the posts first of all increases gradually, then remains constant, then decreases gradually.

22. The optoelectronic device as claimed in claim 17, wherein the computer also generates a first set of 2D symbols representing a change of direction, comprising the following basic elements:
a curve direction arrow indicating the direction of the turn and the angle of the curve;
the name of the next taxiway, said name being placed at the end of the curve direction arrow;
the textual indication of the turn consisting of the text “TURN” and the distance remaining before beginning the turn expressed in meters.

23. The optoelectronic device as claimed in claim 22, wherein the curve direction arrow diminishes when the aircraft advances in the curve, the name of the taxiway being displaced so as to always remain positioned at the end of the curve arrow.

24. The optoelectronic device as claimed in claim 22, wherein the first set of symbols is displayed when the aircraft is less than 200 meters from a curve and disappears at the end of that curve.

25. The optoelectronic device as claimed in claim 17, wherein the computer also generates a second set of 2D symbols representing the situation of the main landing gear of the aircraft and comprising the following basic elements:
a model of the main landing gear of the aircraft, comprising in particular the bogies;
a representation of the taxiway to the same scale as that of the model of the main landing gear;
indices showing the ideal position of the outer bogies of the main landing gear when the airplane is centered on the taxiway.

26. The optoelectronic device as claimed in claim 25, wherein the model of the main landing gear occupies a fixed position in the display, the representation of the taxiway and the indices being mobile.

27. The optoelectronic device as claimed in claim 25, wherein the model of the main landing gear blinks when the main landing gear is too close to the edge of the taxiway.

28. The optoelectronic device as claimed in claim 25, wherein the representation of the taxiway consists of a horizontal line delimited by two vertical lines showing the safety limits of the taxiway.

29. The optoelectronic device as claimed in claim 17, wherein the computer also generates a third set of 2D symbols representing a view from above of the situation of the aircraft on the taxiway and comprising the following basic elements represented to the same scale:
rectangular marks positioned at regular intervals representing the center line of the taxiway;
lateral taxiway safety marks, a series of posts positioned at regular intervals, located either side of the center line of the taxiway and equidistant from the latter;
a model of the landing gear seen from above, comprising all the main landing gear and the nose wheel of the aircraft;
an airplane model representing the aircraft seen from above.

30. The optoelectronic device as claimed in claim 29, wherein the various bogies of the main landing gear and the nose wheel of the aircraft are linked by straight-line segments.

31. The optoelectronic device as claimed in claim 29, wherein said third set is generated to offset the reference loss, when the 3D symbols representing the lateral safety marks are no longer visible in sufficient numbers in the display because of the position of the piloting station in the turns.

32. The optoelectronic device as claimed in claim 31, wherein the display criterion for this third set is the total disappearance of the axial taxiway marks from the field of the display.
